(19) United States
(12) Patent Application Publication
(10) Pub. No.: US 2026/0186888 A1
(43) Pub. Date: Jul. 2, 2026

(54) RULE-BASED AUTOMATED REMEDIATION OF RESOURCES IN DATA CENTERS

(71) Applicant: Microsoft Technology Licensing, LLC, Redmond, WA (US)

(72) Inventors: Vidhi JINDAL, Bellevue, WA (US); Bharath HEGDE, Round Rock, TX (US); Rui ZHENG, Bellevue, WA (US); Heena PARMAR, Redmond, WA (US); FNU Nandan KUMAR, Mill Creek, WA (US); Dana Elena COZMEI, Bellevue, WA (US); Shenee Prakash ASHARA, Atlanta, GA (US)

(21) Appl. No.: 19/003,782

(22) Filed: Dec. 27, 2024

(51) Int. Cl. G06F 11/07

(52) U.S. Cl. CPC G06F 11/0793; G06F 11/0736

(57) ABSTRACT

Systems, methods, and techniques described herein relate to remediating vulnerabilities in data centers. In an aspect, a change in a configuration of a resource is automatically detected. Aggregated data representative of a resource inventory of the data center is generated. The resource inventory specifying a plurality of resources of the data center. A policy of the data center is determined. The policy specifies a rule applied to a resource of the plurality of resources. The resource is determined to fail to satisfy the rule based at least on the change in the configuration and/or the aggregated data. A remedial action is caused to be performed based at least on the resource failing to satisfy the rule. In an aspect, the remedial action comprises identifying a repair action specified in the policy and performing the repair action with respect to the resource.

### BACKGROUND

Data centers are collections of servers maintained by a data center service provider (also referred to as a DC provider). In some implementations, servers can run on different versions of firmware, operating systems, and/or the like and/or have different configuration variables. Different vendors and/or manufacturers can provide servers within the (e.g., same) data center. Bugs in firmware or mistakes in configurations can present vulnerabilities. Malicious entities, such as hackers, can exploit vulnerabilities in data centers to access sensitive data and other resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, devices, and computer readable storage media described herein provide techniques for rule-based automated remediation of resources in data centers. In an aspect, a change in a configuration of a resource is automatically detected. Aggregated data representative of a resource inventory of the data center is generated. The resource inventory specifying a plurality of resources of the data center. A first policy of the data center is determined. The first policy specifies a first rule applied to a first resource of the plurality of resources. The first resource is determined to fail to satisfy the first rule based at least on the change in the configuration and/or the aggregated data. A remedial action is caused to be performed based at least on the first resource failing to satisfy the rule.

In a further aspect, the remedial action comprises: identifying a repair action specified in the first policy; and performing the repair action with respect to the first resource.

In a further aspect, the first rule specifies a pattern of a performance issue in resources. A level of similarity between the pattern of the performance issue and a pattern of a performance of the first resource is determined to satisfy a similarity criterion. The first resource is determined to fail to satisfy the first rule based at least on the level of similarity satisfying the similarity criterion.

In a further aspect, a severity score is determined based at least on the first resource failing to satisfy the first rule. Responsive to the severity score satisfying a severity threshold, the remedial action is caused to be performed.

In a further aspect, a first dataset representative of the resource inventory and a second dataset representative of a security vulnerability of the data center are received. A graph comprising a plurality of nodes and relationships between nodes of the plurality of nodes is generated based at least on the first and second datasets. The plurality of nodes comprises a first node representative of the first resource.

In a further aspect, the graph is utilized to determine the first resource fails to satisfy the first rule based at least on a relationship between the first node and a second node representative of a second resource of the plurality of resources.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for rule-based automated remediation of resources in a data center, in accordance with an embodiment.

FIG. 2 shows a block diagram of a system for automatically remediating resource vulnerabilities in a data center based on rules, in accordance with an embodiment.

FIG. 3 shows a flowchart of a process for automatically remediating resource vulnerabilities in a data center based on rules, in accordance with an embodiment.

FIG. 4 shows a block diagram of a system for monitoring and aggregating data, in accordance with an embodiment.

FIG. 5 shows a flowchart of a process for determining a resource fails to satisfy a rule of a policy, in accordance with an embodiment.

FIG. 6 shows a flowchart of a process for determining a resource fails to satisfy a rule of a policy, in accordance with another embodiment.

FIG. 7 shows an example graph showing a relationship between resources, in accordance with an embodiment.

FIG. 8 shows a flowchart of a process for causing a remedial action to be performed, in accordance with an embodiment.

FIG. 9 shows a flowchart of a process for causing a remedial action to be performed, in accordance with another embodiment.

FIG. 10 shows a flowchart of a process for determining a severity score, in accordance with an embodiment.

FIG. 11 shows a flowchart of a process for determining a severity score, in accordance with another embodiment.

FIG. 12 shows a flowchart of a process for determining whether to cause a remedial action to be performed, in accordance with an embodiment.

FIG. 13 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Rule-based Automated Resource Remediation

Embodiments of the present disclosure relate to resources in a data center (DC). In some implementations, a service provider of a DC (also referred to as a “DC provider”). A DC can have many servers, racks, chassis, and/or other devices and/or components (referred to as “physical resources” hereon). For instance, a DC in an implementation can have tens of thousands of servers; however, embodiments described herein can have fewer or more, depending on the implementation. Physical resources can execute different versions of firmware and/or software (e.g., operating systems, applications, and/or the like). Furthermore, physical resources can be configured with respect to one or more configurations. A configuration can have many configuration variables (e.g., hundreds, thousands, millions, or even greater). Example configuration variables include, but are not limited to, a selection of a hardware component (e.g., a type of processor, a type of accelerator (e.g., a graphics processing unit (GPU), a neural processing unit (NPU), a data accelerator, and/or the like), a storage device, and/or the like), a firmware type or version, an operating system type or version, a service (e.g., an application, a virtual machine, a machine learning (ML) workspace, and/or the like), a configurable property of a hardware component, a configurable property of a service, a vendor of a hardware component or device, a vendor of a service, a manufacturer of a hardware component or device, and/or other variables in configurations of physical resources of a data center.

A vulnerability in a DC is a point in a DC's infrastructure, systems, services, and/or security policies that are potentially exploitable by a malicious entity (e.g., a hacker). Vulnerabilities in DCs can occur for several different reasons. For instance, in some implementations, a vulnerability is caused by a bug (or other error) in firmware or software executed by a physical resource. In some other implementations, a vulnerability is caused by a mistake in a configuration of the physical resource. A malicious entity can exploit a vulnerability in the DC to access sensitive data and/or resources (e.g., physical resources, virtual resources (e.g., services executing on physical resources, data stored in memory of a physical resource, and/or the like), and/or the like). In some implementations, configurations can change during run time of physical resources, can change based on connections to other resources (e.g., dependent resources (also referred to as “child resources” herein), resources the resource depends on (also referred to as “parent resources” herein), resources the resource operates with respect to (e.g., “sibling resources” and/or the like), and/or the like), can change based on repairs to a resource, and/or the like. These changes can introduce new vulnerabilities or expose a (e.g., new) resource to an existing vulnerability.

Embodiments of the present disclosure automatically detect vulnerabilities and cause remediation of the vulnerabilities in DCs. For instance, in an aspect, a detection and compliance engine automatically detects a change in a configuration of a resource in a DC. The engine generates aggregated data representative of a resource inventory of the DC specifying a plurality of resources comprising the resource. Depending on the implementation, the plurality of resources can be an entire group of resources of a DC, a portion of resources of a DC comprising the resource (e.g., resources in a room of a DC comprising the resource, resources of a tile of servers comprising the resource, and/or the like), a group of resources related to the resource (e.g., parent resources, child resources, sibling resources, and/or the like), and/or other group or subgroups of resources of the DC. Data can be aggregated from different sources such as, but not limited to, monitoring resources of the DC, a predefined list of data, an external service, and/or the like. The engine determines one or more policies specifying one or more rules applied to resources of the DC and determines if the resource fails to satisfy the rule based at least on the change in the configuration and/or the aggregated data. In response to determining the resource fails to satisfy the rule, the engine can cause a remedial action to be performed with respect to the resource or a vulnerability identified based on the failure. In this manner, embodiments automatically detect and mitigate vulnerabilities in a DC.

Furthermore, in embodiments, the detection and compliance engine is implemented within a DC. In this context, the detection and compliance engine operates without a direct dependency on services or devices outside of the DC. For instance, in an embodiment where vulnerability information from a public database is used, an implementation of the engine accesses the vulnerability information and stores a local copy. In this context, the detection and compliance engine is able to evaluate physical resources, detect changes, and implement remediation techniques with respect to detected vulnerabilities without relying on external services or devices during compliance evaluation. This allows the system to operate with lower latency, as few communications outside the DC are needed (and, in some implementations, none during regular runtime detection).

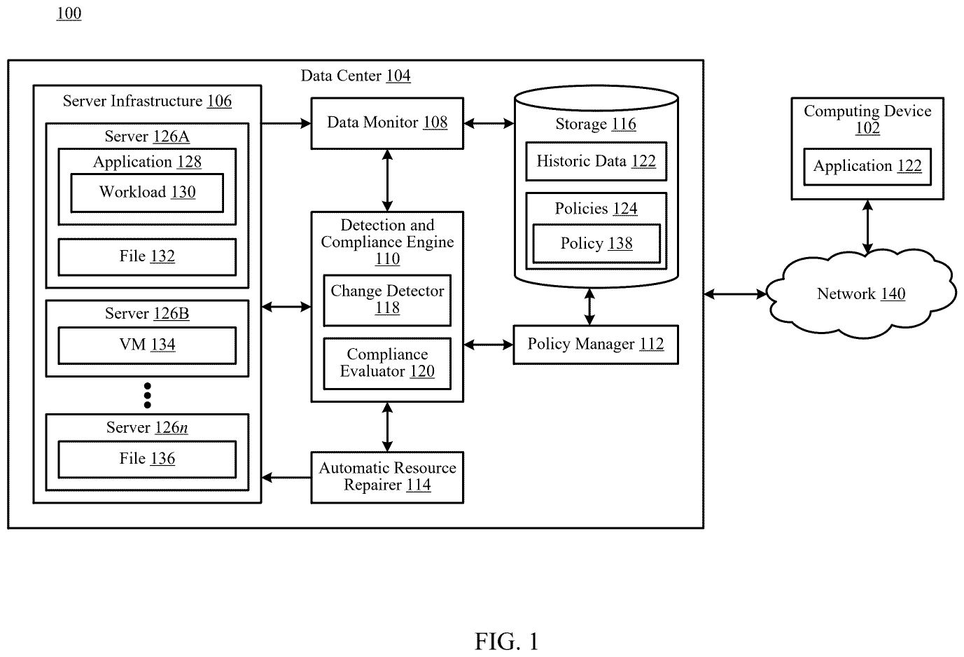

Embodiments are configurable to automatically detect and mitigate vulnerabilities in DCs in various ways. For example, FIG. 1 shows a block diagram of a system 100 for rule-based automated remediation of resources in a data center, in accordance with an embodiment. As shown in FIG. 1, system 100 comprises a computing device 102 and a data center 104 (“DC 104” herein), each of which are communicatively coupled via a network 140 (in an embodiment). In examples, network 140 comprises one or more networks such as local area networks (LANs), wide area networks (WANs), enterprise networks, the Internet, etc. In examples, network 140 comprises one or more wired and/or wireless portions. The features of system 100 are described in detail as follows.

In examples, computing device 102 is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a user (e.g., an individual user, a group of users, an organization, a family user, a customer user, an employee user, an admin user (e.g., a service team user, a developer user, a management user, etc.), etc.). Computing device 102 is configured to execute an application 122. In accordance with an embodiment, application 122 enables a user to interface with DC 104.

DC 104 is configured to house servers and/or other computing systems and associated components. In some embodiments, DC 104 is a building. Alternatively, DC 104 is a dedicated portion of a building. In some embodiments, DC 104 is a group of buildings (e.g., collocated, within the same region, or distributed across different regions). DC 104 can have one or more rooms utilized to store the servers. In an embodiment, servers of DC 104 are arranged in a collocated (e.g., same building and/or room of DC 104) or distributed (e.g., across buildings and/or rooms of DC 104) server infrastructure. For instance, as shown in FIG. 1, DC 104 comprises a server infrastructure 106. Server infrastructure 106 comprises server 126A, server 126B, and server 126n (“servers 126A-126n” herein). Servers 126A-126n are physical resources of server infrastructure 106. In some embodiments, servers of servers 126A-126n are grouped into clusters (e.g., based on type, randomly, based on configurations, based on association with tenants and/or customers, based on utilization, and/or the like).

In embodiments, servers 126A-126n are configured to host applications, host virtual nodes, store data, and/or provide other services of a service provider associated with server infrastructure 106. For example, as illustrated in FIG. 1, server 126A hosts an application 128 and stores a file 132, server 126B hosts a virtual machine 134 (“VM 134” herein), and server 126n stores a file 136. In an embodiment, application 128 is a cloud application (e.g., a remote desktop application, a backend cloud application, a virtual machine, and/or the like). Files 132 and 136 comprise data stored in a server (e.g., on behalf of a user account, on behalf of a tenant, generated by an application, and/or the like). While files are shown in FIG. 1, data stored by one or more of servers 126A-126n can be stored in other ways (e.g., as structured or unstructured data). VM 134 is a virtual environment for running applications. Depending on the implementation, two or more of application 128, file 132, VM 134, and/or file 136 are associated with the same tenant or user account. Alternatively, application 128, file 132, VM 134, and file 136 are associated with different tenant or user accounts.

In embodiments, applications hosted by servers 126A-126n, such as application 128, execute one or more workloads. For instance, as shown in FIG. 1, application 130 executes a workload 130. Workload 130 comprises one or more tasks and/or jobs. In an embodiment, a workload is performed across multiple services and/or physical resources. In an embodiment, an application is part of a workload. For instance, in an embodiment, workload 130 comprises a task to execute application 130 on server 126A.

In embodiments, DCs such as DC 104 comprise supporting services and/or devices that manage and/or otherwise interact with server infrastructure 106. For instance, as shown in FIG. 1, in addition to server infrastructure 106, DC 104 further comprises a data monitor 108, a detection and compliance engine 110, a policy manager 112, an automatic resource repairer 114, and a storage 116. Storage 116 is configured to store data utilized by and/or generated by data monitor 108, detection and compliance engine 110, policy manager 112, automatic resource repairer 114, and/or components thereof and/or services executing thereon. For instance, as shown in FIG. 1, storage 116 stores historic data 122 and policies 124. Historic data 122 comprises data previously monitored and/or generated by data monitor 108 (e.g., a monitoring log indicating previous monitoring results generated by data monitor 108). Policies 124 comprise one or more policies that specify one or more rules with respect to resources of DC 104. Storage 116 is shown as separate from server infrastructure 106. Alternatively, storage 116 is implemented as a memory device of one or more of servers 126A-126n.

Data monitor 108 is implemented as hardware and/or software executed by hardware and is configured to monitor data associated with server infrastructure 106 and/or other components of DC 104. For instance, in an embodiment, data monitor 108 monitors an inventory of physical resources of server infrastructure 106 (also referred to as a “resource inventory” herein), monitors a lifecycle of resources of server infrastructure 106, monitors vulnerabilities of DC 104, monitors potential vulnerabilities that could affect DC 104, monitors components associated with physical resources of infrastructure 106, monitors services hosted by servers 126A-126n, and/or monitors other data associated with DC 104, as described elsewhere herein. In an embodiment, data monitor 108 monitors data associated with all of DC 104. Alternatively, multiple data monitors monitor data associated with respective portions of DC 104. For instance, in an embodiment, a separate data monitor or group of data monitors is utilized to monitor data associated with physical resources of a respective room, row, or rack of DC 104. In an embodiment, data monitor 108 comprises a telemetry device. In an embodiment, data monitor 108 stores monitored data or a log of monitored data as historic data 122 in storage 116. In an embodiment, data monitor 108 is implemented as a service executed by a server or servers of servers 126A-126n.

Policy manager 112 is a computer-implemented component or sub-service configured to manage policies physical resources of DC 104 are subject to. For instance, policy manager 112 in an example manages policies 124. In an embodiment, policy manager 112 generates one or more of policies 124 and/or rules thereof, modifies one or more of policies 124 and/or rules thereof, and/or enforces one or more of policies 124 and/or rules thereof. In an embodiment, a user interacts with policy manager 122 (e.g., via application 122 over network 140) in order to generate a policy, store a policy, update a policy, modify a policy, and/or delete a policy.

As described herein, policy manager 112 manages policies 124 stored in storage 116. Examples of policies include, but are not limited to, access policies, security policies, configuration policies, and/or any other type of policy that specifies a rule a resource is to follow or be configured with respect to. An access policy specifies one or more rules that define access to or utilization of a physical resource, a component of a resource, data stored by a physical resource, a service hosted by a physical resource, and/or the like. A security policy specifies one or more rules related to security of a physical resource and/or services hosted thereby. For instance, a security policy can specify a rule that defines a credential type data or a service are to be protected by, a rule that defines a rule of an access policy, a rule that defines a communication protocol or type to be used by a physical resource or a service hosted thereby, a rule that defines an acceptable file format or type, and/or another type of rule related to security of a physical resource, services hosted thereby, and/or data stored thereby. A configuration policy specifies one or more rules that define how a physical resource is to be configured, e.g., a type of firmware or software to utilize on a physical resource, operating conditions for the physical resource, operation or utilization limitations of the physical resource, recommended property configurations for a physical resource, compatible components of a physical resource, and/or any other specification on a configuration of a physical resource. Policies can be defined by a user or tenant that utilize resources of DC 104, a service provider associated with DC 104, a manufacturer or vendor of a physical resource or a component, a vendor of a service hosted by a physical resource, and/or the like.

In embodiments, policies of policies 124 are authored by particular authorities. For instance, in an example, a configuration policy for a physical resource or component can be authored by a manufacturer authority (e.g., the manufacturer of the physical resource or component or a user on behalf of the manufacturer (e.g., a policy admin user of the manufacturer)), a service provider authority (e.g., a service provider that provides servers 126A-126n), a user authority (e.g., a tenant or user that intends to utilize the physical hardware and/or component). In an example, a security and/or access policy is authored by a service provider authority (e.g., a security admin of a service provider that defines or enforces security policies of the service provider) or a user authority (e.g., a tenant or user admin that defines or enforces security policies of the user or tenant). Depending on the implementation, multiple types of policies or multiple policies of the same type authored by different authorities can apply to the same resource. While policies are described as being authored or managed by users, in some embodiments, an automated system generates, manages, and/or enforces policies based on predetermined rules, definitions, and/or settings.

In some embodiments, a policy of policies 124 specifies one or more remedial actions to perform if a rule is not satisfied. For instance, in accordance with an embodiment, a policy specifies a server is to be rebooted, repaired, or have its memory cleared if a rule is not satisfied. In a non-limiting example, a configuration policy specifies a debug flag is to be enabled if disabled. In another non-limiting example, a configuration policy specifies firmware of the physical resource is to be updated/changed to a specific firmware version.

Detection and compliance engine 110 is a computer-implemented component and/or service of DC 104 that is configured to automatically detect changes in a physical resource of DC 104 and determine if the resource is compliant with policies the resource is subject to. As shown in FIG. 1, detection and compliance engine 110 comprises change detector 118 and compliance evaluator 120, implemented as subservices and/or subcomponents of detection and compliance engine 110. Change detector 118 is configured to automatically detect a change in a physical resource of server infrastructure 106. Example changes include, but are not limited to, an addition of a new physical resource, removal of a physical resource, repair to a physical resource, a change in a configuration of a physical resource, a change in a component of a physical resource, a change in a virtual resource hosted by a physical resource, a change in a property of a physical resource and/or a virtual resource hosted thereby, a change in a state of a life cycle of a physical resource, a new relationship between physical resources, a change in a relationship between physical resources, and/or the other changes in a physical resource, its components, and/or virtual resources hosted thereby.

Compliance evaluator 120 is configured to evaluate whether or not physical resources of server infrastructure 106 are in compliance with policies 124 and, if not, cause a remedial action to be performed with respect to the resource or the vulnerability. In an embodiment, compliance evaluator 120 evaluates compliance based on changes detected by change detector 118. By automatically evaluating compliance based on detected changes to physical resources, compliance evaluator 120 conserves compute resources expended in evaluating compliance, as (e.g., only) the changed resource (and, optionally, other impacted resources) are evaluated (e.g., as opposed to scanning all resources). Furthermore, by evaluating compliance in response to (e.g., any) changes in a physical resource, embodiments described herein are able to identify potential vulnerabilities in DC 104 that appear during runtime, repair, or new/modified connections with other physical resources.

As described herein, compliance evaluator 120 causes a remedial action to be performed if a resource is not compliant with a policy. Depending on the implementation, compliance evaluator 120 performs the remedial action or causes another component and/or service of DC 104 to perform the remedial action. Example remedial actions include, but are not limited to, performing a repair action to repair a vulnerability (e.g., repair a mistake in a configuration, repair a bug in firmware, and/or the like), disabling a physical resource or component thereof, ceasing a workload or service executing on a physical resource (e.g., a workload that is experiencing an error or is (e.g., potentially) malicious, an application that is failing, an application that is linked to (e.g., potential) malicious activity, and/or the like), alerting a user account or tenant account impacted by the vulnerability, alerting a developer associated with the physical resource (e.g., via e-mail, via an application notification, via a text message, via an automated phone call, and/or the like), an application executing thereon, a component thereof, and/or the like of the identified vulnerability or other failure in compliance (e.g., via e-mail, via an application notification, via a text message, via an automated phone call, and/or the like), indicating to policy manager 112 or a developer associated with the policy that the resources does not satisfy the rules of the policy, updating a policy or a policy rule (e.g., updating a policy based on a pattern of a vulnerability or error corresponding to a version of software or firmware, a configuration, or a component), and/or any other type of action intended to mitigate the resource's failure in satisfying the rule of the policy.

For instance, suppose compliance evaluator 120 determines server 126A fails to satisfy a rule of policy 138 and executes a first version of firmware. Further suppose compliance evaluator 120 had previously determined server 126B failed to satisfy the same rule of policy 138 and executes the same first version of firmware and server 126B satisfied the rule once the first version of firmware was updated to a second version of the firmware (e.g., a newer version, a rollback version, and/or the like). In this context, compliance evaluator 120 can determine a pattern of behavior of the first version of the firmware causes servers to fail the rule of policy 138. If the pattern satisfies a pattern condition (e.g., a predetermined number of physical resources perform or mitigate based on the pattern), compliance evaluator 120 can cause policy 138 to be updated to indicate the faulty behavior occurs based at least on the first version of the firmware and can be mitigated by changing to the second version of the firmware.

Automatic resource repairer is a computer-implemented component and/or service that is configured to perform repair actions with respect to resources and/or vulnerabilities in DC 104. As shown in FIG. 1, automatic resource repairer is separate from detection and compliance engine 110. Alternatively, detection and compliance engine 110 and automatic resource repairer 114 are integrated in the same device/service, e.g., as a compliance and repair engine. Example repair actions include, but are not limited to, flagging the physical resource for manual repair, updating firmware of the physical resource, updating software of the physical resource, changing an operating system of the physical resource, disabling a component of the physical resource, (e.g., temporarily) disabling the physical resource, migrating a workload from the physical resource to another physical resource, pausing a workload executing on the physical resource, restarting a physical resource, restarting a service hosted by the physical resource, factory resetting a physical resource, defragmenting data stored by a memory device of a physical resource, disabling a network session of a physical resource, re-establishing a network session of a physical resource, establishing a network session of a physical resource, and/or any other type of action intended to repair a physical resource, software or firmware executed by a physical resource, and/or a vulnerability of a physical resource, e.g., as described elsewhere herein.

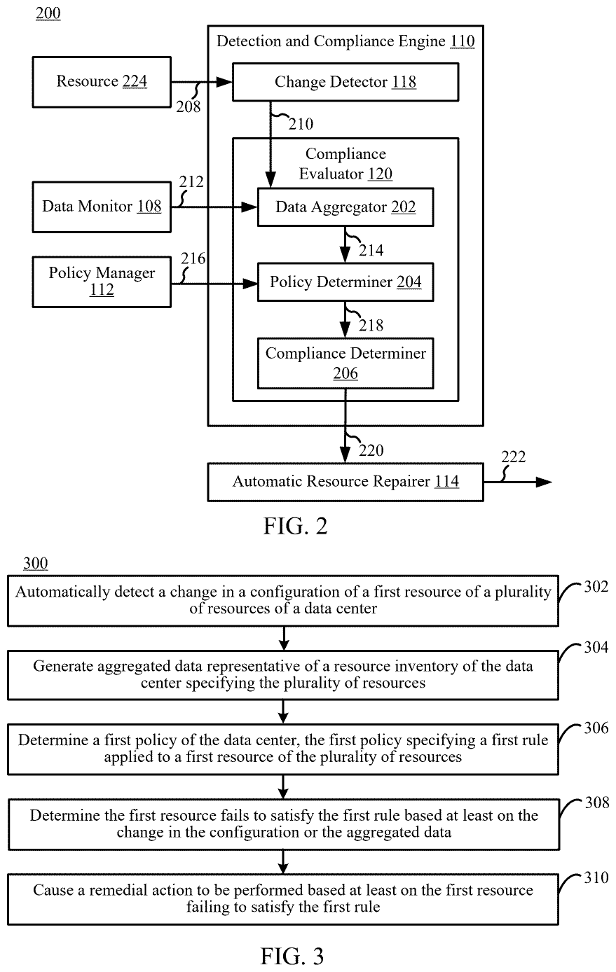

Embodiments of detection and compliance engines and automatic resource repairers are configurable in various ways. For instance, FIG. 2 shows a block diagram of a system 200 for automatically remediating resource vulnerabilities in a data center based on rules, in accordance with an embodiment. As shown in FIG. 2, system 200 comprises data monitor 108, detection and compliance engine 110 (comprising change detector 118 and compliance evaluator 120), policy manager 112, and automatic resource repairer 114, as described with respect to FIG. 2, as well as a resource 224. Resource 224 is any type of physical resource of DC 104, as described herein. For instance, in an embodiment, resource 224 is an example of a server of servers 126A-126n. As also shown in FIG. 2, compliance evaluator 120 comprises a data aggregator 202, a policy determiner 204, and a compliance determiner 206, each of which are implemented as sub-services and/or sub-components of compliance evaluator 120.

To better understand the operation of detection and compliance engine 110 of FIG. 2, system 200 is described with respect to FIG. 3. FIG. 3 shows a flowchart 300 of a process for automatically remediating resource vulnerabilities in a data center based on rules, in accordance with an embodiment. In an embodiment, detection and compliance engine 110 operates according to one or more steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a change in a configuration of a first resource of a plurality of resources of a data center is automatically detected. For instance, change detector 118 receives resource information 208 and automatically detects a change in a configuration of resource 224. Depending on the implementation, resource information 208 is a telemetry report of activity of resource 224, a log of activity of resource 224, a telemetry stream of activity of resource 224, a query response indicating activity and/or other information regarding resource 224 (e.g., in response to a scan or query from change detector 118), and/or other information regarding resource 224 otherwise provided to change detector 118. In accordance with an embodiment, change detector 118 periodically checks configurations of resources (including resource 224) (e.g., by receiving resource information 208) and, upon detecting a change, assigns a fault code. In accordance with another embodiment, change detector 118 detects a change based on a triggering event (e.g., in which resource information 208 is provided to change detector 118). Examples of triggering events include, but are not limited to, resource 224 being added as a new resource to server infrastructure 106, resource 224 being re-added to server infrastructure 106 subsequent to a repair or update, a change in firmware or software of server infrastructure 106, addition or removal of a component of resource 224, a change in a configuration of resource 224, resource 224 being flagged or submitted for certification, resource 224 (e.g., unexpectedly) rebooting, and/or the like. In an embodiment, and as shown in FIG. 2, change detector 118 provides a change detection signal 210 to data aggregator 202. Change detection signal 210 comprises information/data about the detected change in resource 224.

In step 304, aggregated data is generated, the aggregated data representative of a resource inventory of the data center specifying the plurality of resources. For example, data aggregator 202 of FIG. 2 generates aggregated data 214 representative of a resource inventory of DC 104 specifying a plurality of resources. In an embodiment, data aggregator generates aggregated data 214 based at least on change detection signal 210 and/or monitored data 212 from data monitor 108. In accordance with an embodiment, data aggregator 202 generates aggregated data 214 as a graph comprising nodes and edges representing relationships between the nodes. The nodes represent resources of DC 104, associated data, and/or associated accounts. Additional details regarding generating and utilizing graphs are described with respect to FIGS. 6 and 7, as well as elsewhere herein. In an embodiment, the graph is stored in a cache and utilized for a predetermined time or a predetermined number of compliance evaluations.

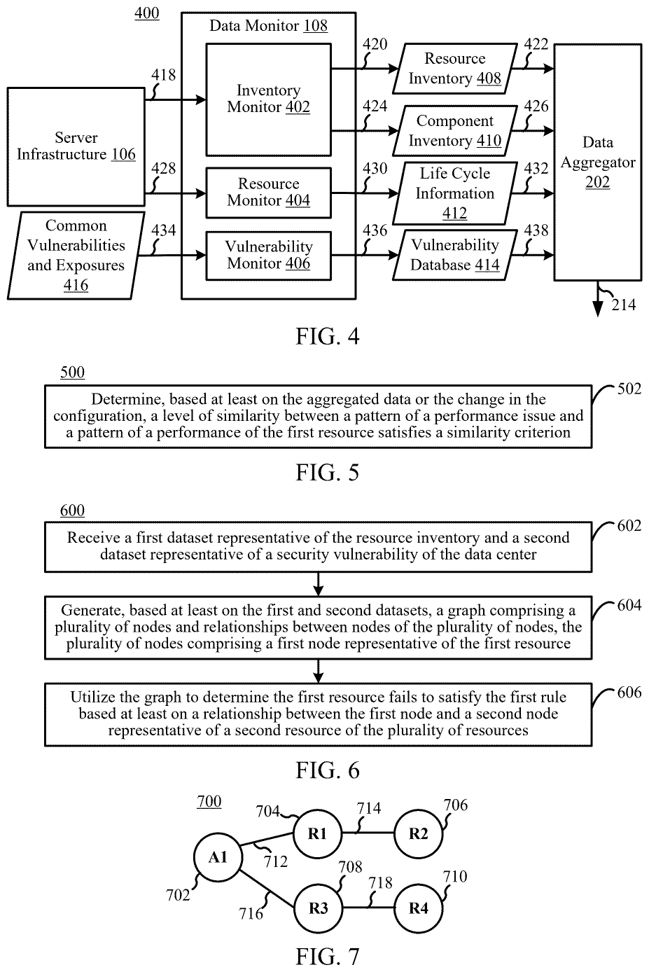

In an embodiment, data aggregator 202 queries data monitor 108 (or stored data generated by data monitor 108) for monitored data 212 and generates aggregated data 214 based at least on monitored data 212. For instance, in an example data aggregator 202 queries data monitor 108 based on the triggering event that caused the detected change in the resource, e.g., by querying for data related to the resource (e.g., associated with an identifier of the resource), by querying for data related to impacted resources, by querying for data based on the type of triggering event (e.g., security data based on a security event triggering the detection, configuration and inventory data based on a fault in a configuration or component operation, and/or the like). For example, in accordance with an embodiment, data aggregator 202 generates aggregated data 214 based on identifiers of resources (e.g., resource 224) in monitored data 212. In some embodiments, data monitor 108 comprises multiple (e.g., different types of) monitors that generate respective monitored data 212. For instance, and as described further with respect to FIG. 4, as well as elsewhere herein, in an embodiment, data monitor 108 comprises an inventory monitor that generates monitored data specifying an inventory of DC 104, a resource monitor that generates monitored data specifying a lifecycle of resources of DC 104, and a vulnerability monitor 406 that generates monitored data specifying a vulnerability of datacenters or resources. In this context, a resource such as resource 224 can have a different identifier depending on the data type. If so, data aggregator 202 utilizes a mapping of identifiers that maps the different identifiers of resource 224 (and, optionally, associated components) to aggregate the data into aggregated data 214.

In step 306, a first policy of the data center is determined, the first policy specifying a first rule applied to a first resource of the plurality of resources. For instance, in accordance with an embodiment, policy determiner 204 of FIG. 2 determines policy 138 of policies 124 applicable to resource 224 specifying a first rule applied to resource 224. Depending on the implementation, policy determiner 204 determines one or more policies that are applicable based at least on: the fault code assigned by change detector 118; the change detected by change detector 118; a connection resource 224 has with another resource, an account, and/or data; a configuration of resource 224; a configuration of a connected/related resource; and/or other information associated with the change and/or aggregated data 214. The one or more policies specify one or more respective rules applied to resource 224. A policy can specify any number of rules (e.g., one rule, more than one rule, tens of rules, hundreds of rules, and/or even greater numbers of rules). As shown in FIG. 2, policy determiner 204 accesses the policies via a policy signal 216 received from policy manager 112. In an embodiment, policy determiner 204 transmits a query to policy manager 112 specifying a resource identifier of resource 224 or an identifier of a cluster, tenant, or user resource 224 is associated with. In this context, policy manager 112 obtains one or more policies of policies 124 that are related to the resource, its associated cluster, its associated tenant, and/or its associated user (e.g., based on the identifiers included in the query) (e.g., stored in storage 116) and provides them to policy determiner 204 via policy signal 216. In an alternative, policy determiner 204 accesses policies stored in storage 116 (e.g., directly).

In an embodiment, policies 124 are determined by external entities (e.g., users, service providers, organizations, manufacturers, and/or the like). In accordance with another embodiment, policy determiner 204 and/or policy manager 112 automatically determine a policy. For instance, in accordance with an embodiment, policy determiner 204 automatically generates a policy based on a potential security vulnerability. For instance, suppose a manufacturer publishes or otherwise makes available a security vulnerability with respect to a component or resource it manufactures. In this context, policy determiner 204 or policy manager 112 detects or receives indication of the published vulnerability, determines which component or resources are at risk, and generates a rule that specifies criteria the component or resource are to satisfy to mitigate the risk.

In step 308, the first resource is determined to fail to satisfy the first rule based at least on the change in the configuration and/or the aggregated data. For example, compliance determiner 206 determines resource 224 fails to satisfy a first rule of policy 138 based at least on change detection signal 210 and/or aggregated data 214. In an embodiment, compliance determiner 206 determines if resource 224 satisfies one or more rules of policy 138 using paths defined by the policy. In this context, policy schema of policy 138 is defined as a graph. In an example, the graph represents policy 138 as a hierarchical system that shows relationships between rules of policy 138, resources policy 138 applies to, relationships between policy 138 and another policy, expected and/or required attributes of a resource policy 138 applies to, and/or the like. The graph comprises paths between nodes representative of the different rules and relationships that check whether or not data provided thereto satisfies rules. This type of schema is also referred to as “flash rules” herein. Aggregated data 214 is fed into the graph to determine if resource 224 satisfies rules of policy 138. Compliance determiner 206 determines if aggregated data 214 passes the one or more paths of the flash rule. If so, resource 224 satisfies policy 138 and another policy is checked (e.g., if multiple policies apply to resource 224) or the process ends. If aggregated data 214 fails to pass one or more of the paths of the flash rule, compliance determiner 206 determines resource 224 fails to satisfy at least one rule of policy 138 and flowchart 300 continues to step 310.

In accordance with another embodiment, policy 138 defines one or more query language statements for determining whether or not resource 224 is in compliance with the one or more rules of policy 138. In this context, aggregated data 214 is structured in a manner to be queried using the query language statements. If any of the query language statements indicate the resource is not compliant, flowchart 300 continues to step 310.

In step 310, a remedial action is caused to be performed based at least on the first resource failing to satisfy the first rule. For example, compliance determiner 206 of FIG. 6 causes a remedial action to be performed based at least on the determination made in step 308. In an embodiment, compliance determiner 206 performs the remedial action. Alternatively, compliance determiner 206 causes another component of system 200 or DC 104 to perform the remedial action. For instance, as shown in FIG. 2, compliance determiner 206 provides instructions 220 to automatic resource repairer 114 to perform the remedial action, e.g., a repair action 222. In an embodiment, a remedial action comprises marking resource 224 as faulty and applying a mitigation configuration. In an embodiment, the mitigation configuration is specified in the policy the resource fails to satisfy.

In an embodiment, compliance determiner 206 causes the remedial action to be simulated. In this context, compliance determiner 206 or automatic resource repairer 114 simulate an expected outcome of the remedial action (e.g., how many resources are impacted or made offline by the action, how long resources undergo repair, a likelihood a workload will be throttled if the remedial action is performed, and/or other potential outcomes of an action). In this context, compliance determiner 206 or automatic resource repairer 114 are able to determine if a remedial action's impact is likely to stay within boundaries of the system. For instance, if a remedial action is going to take too many resources offline a time (e.g., a number of physical resources over a threshold) or reduce capacity of DC 104 for too long (e.g., a length of time longer than a capacity reduction limit), the remedial action can be modified or cancelled. For instance, in an embodiment where a number of physical resources taken offline exceeds a predetermined number, compliance determiner 206 divides the remedial action into multiple actions with respect to fewer number of physical resources over a period of time. In this context, smaller batches of resources are taken offline in order to satisfy DC 104's capacity requirements.

Data aggregator 202 of FIG. 2 is configured to aggregate data in various ways, in embodiments. For example, FIG. 4 shows a block diagram of a system 400 for monitoring and aggregating data, in accordance with an embodiment. As shown in FIG. 4, system 400 comprises server infrastructure 106 and data monitor 108, as described with respect to FIG. 1, data aggregator 202, as described with respect to FIG. 2, as well as a resource inventory 408, a component inventory 410, a life cycle information 412, a vulnerability database 414, and a common vulnerabilities and exposures 416. In an embodiment, resource inventory 408, component inventory 410, life cycle information 412, vulnerability database 414, and common vulnerabilities and exposures 416 are datasets. For instance, in an embodiment, resource inventory 408, component inventory 410, life cycle information 412, and/or vulnerability database 414 are datasets stored as historic data 122. Resource inventory 408 specifies information regarding resources of DC 104 (e.g., the servers, connectivity of the servers to racks, and/or the like). Component inventory 410 specifies information regarding components within resources of DC 104 (e.g., a kind of processor a server of servers 126A-126n has, processing cycle speed of the processor, accelerators of the server, storage devices of the server, and/or other information regarding the components of servers or other resources of DC 104). Life cycle information 412 specifies life cycle state information of resources of DC 104, as described elsewhere herein. In an embodiment, common vulnerabilities and exposures 416 (“CVEs 416” herein) are stored as a list or other type of data, e.g., in storage 116. In another embodiment, CVEs 416 are maintained in a network-accessible database. In this alternative, data monitor 108 (or a component thereof) accesses CVEs 416 from the network-accessible database over network 140. In an embodiment, data monitor 108 accesses CVEs 416 on-demand. Alternatively, data monitor 108 routinely accesses CVEs 416 to check for updates and stores a local copy of the most recent version of CVEs 416. In another alternative, data monitor 108 receives an updated version of CVEs 416 (e.g., when there is an update, on a periodic basis, and/or the like).

In embodiments, data monitor 108 operates in order to update and/or otherwise maintain resource inventory 408, component inventory 410, life cycle information 412, and vulnerability database 414. For instance, as shown in FIG. 4, data monitor 108 comprises an inventory monitor 402, a resource monitor 404, and a vulnerability monitor 406, each of which are implemented as subservices and/or subcomponents of data monitor 108. Inventory monitor 402 is configured to monitor resource and component inventories of server infrastructure 106 via an inventory monitoring signal 418, update resource inventory 408 via an inventory update signal 420, and update component inventory 410 via an inventory update signal 424. In an embodiment, inventory monitor 402 comprises logic to detect changes based on inventory monitoring signal 418. In this implementation, inventory monitor 402 generates inventory update signal 420 and/or inventory update signal 424 (e.g., only) if there is a change. In this manner, fewer resources are expended in storing/updating resource inventory 408. Alternatively, inventory monitor 402 generates a log of (e.g., all) of the resources and/or components of server infrastructure 106 based on inventory monitoring signal 418 and updates resource inventory 408 to include a resource inventory log via inventory update signal 420 and updates component inventory 410 to include a component inventory log via inventory update signal 424. In this context, the logic of inventory monitor 402 can be simplified (e.g., by not including logic to determine if changes occur). In an embodiment, inventory monitor 402 scans resources of server infrastructure 106 to receive inventory monitoring signal 418. In this context, a scan of each resource or group of resources is received as a separate monitoring signal. In an alternative embodiment, server infrastructure 106 comprises an inventory reporter that generates a report of component and/or resource inventory to provide to inventory monitor 402. In an embodiment, such an inventory report (e.g., only) generates the report if the inventory changes (e.g., a component and/or resource is added to or removed from server infrastructure 106).

Resource monitor 404 is configured to monitor the life cycle of physical resources of server infrastructure 106 via a life cycle monitoring signal 428. Depending on the implementation, resource monitor 404 scans physical resources to receive life cycle monitoring signal 428, transmits a request for life cycle monitoring signal 428, receives a report as life cycle monitoring signal 428, and/or the like. In an embodiment, life cycle monitoring signal 428 comprises state information for physical resources and/or components representing a life cycle state of the physical resource and/or component. Example life cycle states include, but are not limited to, a new state (e.g., the physical resource and/or component has been added to server infrastructure 106 within a predetermined period of time (e.g., since the last scan for life cycle information)), a pre-configuration (or default) state (e.g., the physical resource and/or component is in its default state before a (e.g., custom) configuration has been applied), an uncertified state (e.g., the physical resource and/or component has yet to be certified according to one or more policies), a certified state (e.g., the physical resource and/or component has been certified according to one or more policies), a repair state (e.g., the physical resource and/or component is being repaired or has been flagged for repairs), a disabled state (e.g., the physical resource and/or component are not being used and/or are not available for use), an isolated state (e.g., communication links with the physical resource and/or component are prohibited or restricted), a stale state (e.g., a certification of the physical resource and/or component has expired or needs to be updated), an end-of-life (EOL) state (e.g., the physical resource and/or component are flagged for replacement or removal), and/or another type of state in the life cycle of the physical resource and/or component. As shown in FIG. 4, resource monitor 404 updates life cycle information 412 based on life cycle information received in life cycle monitoring signal 428 via a life cycle update signal 430. In an embodiment, resource monitor 404 periodically checks (e.g., scans or requests) the life cycle state of resources of server infrastructure 106, detects any changes, and updates the changes in life cycle information 412.

Vulnerability monitor 406 is configured to detect potential vulnerabilities or exposures DC 104 could be affected by and update vulnerability database 414 via a vulnerability update signal 436. In an embodiment, and as shown in FIG. 4, vulnerability monitor 406 receives vulnerability information 434 from CVEs 416. In an embodiment, vulnerability information 434 comprises all of CVEs 416. Alternatively, vulnerability information 434 comprises changes/updates in CVEs 416 since a previous update was received by vulnerability monitor 406. In an embodiment, vulnerability monitor 406 requests CVEs 416 (e.g., periodically) from a network-accessible service or database. In an embodiment, CVEs 416 are maintained as a publicly available list available for search, download, copy, redistribution, reference, and/or analysis. In an embodiment, vulnerability monitor 406 filters vulnerability information 434 before updating vulnerability database 414. For instance, in accordance with an embodiment, vulnerability monitor 406 removes vulnerabilities that apply to resources not included in server infrastructure 106, software not utilized by resources of server infrastructure 106, file formats not stored or accessed by resources, and/or other vulnerability information irrelevant to server infrastructure 106 and/or data center 104.

As described herein, data aggregator 202 generates aggregated data 214. For instance, in an embodiment, data aggregator 202 generates aggregated data 214 based at least on one or more of resource inventory 408, component inventory 410, life cycle information 412, and/or vulnerability database 414, in embodiments. As shown in FIG. 4, data aggregator 202 receives resource inventory information 422 comprising a portion or all of resource inventory 408, component inventory information 426 comprising a portion or all of component inventory 410, life cycle information 432 comprising a portion or all of life cycle information 412, and vulnerability information 438 comprising a portion or all of vulnerability database 414. In an embodiment, data aggregator 202 requests for or accesses a respective store to obtain resource inventory information 422, component inventory information 426, life cycle information 432, and/or vulnerability information 438 in response to a detected change in a resource of server infrastructure 106 (e.g., a change detected by change detector 118 as described with respect to step 302 of flowchart 300 of FIG. 3). In an embodiment, the request or access is for all of information stored by the respective store. Alternatively, the request or access specifies a resource or a subset of resources information is to be obtained/provided for.

Aggregated data generated by data aggregator 202 can be utilized in various ways, in embodiments. For instance, in an embodiment, compliance evaluator 206 of FIG. 2 operates to determine a pattern in a performance of a resource and/or related resources. In an embodiment, compliance evaluator 206 operates to determine whether or not a resource satisfies a rule of a policy based at least on the determined pattern. For instance, FIG. 5 shows a flowchart 500 of a process for determining a resource fails to satisfy a rule of a policy, in accordance with an embodiment. In an embodiment, compliance evaluator 206 operates according to the step of flowchart 500. Note that not all steps of flowchart 500 need be performed in all embodiments. Further structural and operational embodiments will be apparent to persons skilled in the relevant art(s) based on the following description of FIG. 5 with respect to FIG. 2.

Flowchart 500 comprises step 502. In step 502, a level of similarity between a pattern of a performance issue and a pattern of a performance of the first resource is determined to satisfy a similarity criterion based at least on the aggregated data and/or the change in the configuration. For example, compliance determiner 206 of FIG. 2 determines a level of similarity between a pattern of a performance issue (e.g., a pattern of a performance issue defined by policy 138, a pattern of a performance issue stored in historic data 122, and/or the like) and a pattern of a performance of resource 224 (e.g., determined based on aggregated data 214). Compliance determiner 206 determines if the determined level of similarity satisfies a similarity criterion. If the level of similarity satisfies the criterion, the resource is determined to fail a rule of policy 138 and flow continues in a similar manner as described with respect to step 310 of FIG. 3. If not, the resource is determined to satisfy (e.g., at least this portion of) policy 138.

As described herein, in some embodiments, detection and compliance engine 110 of FIG. 2 determines if a resource fails to satisfy a rule of policy based at least on aggregated data (e.g., aggregated data 214). Aggregated data 214 can be represented and/or utilized in various ways, in embodiments. For instance, FIG. 6 shows a flowchart 600 of a process for determining a resource fails to satisfy a rule of a policy, in accordance with another embodiment. In an embodiment, detection and compliance engine 110 operates according to one or more steps of flowchart 600. Note that not all steps of flowchart 600 need be performed in all embodiments. Further structural and operational embodiments will be apparent to persons skilled in the relevant art(s) based on the following description of FIG. 6 with respect to FIGS. 2 and 4.

Flowchart 600 begins with step 602. In step 602, a first dataset representative of the resource inventory and a second dataset representative of a security vulnerability of the data center are received. For example, as shown in FIG. 4, data aggregator 202 receives resource inventory information 422 (e.g., a first dataset representative of a resource inventory of DC 104) and vulnerability information 438 (e.g., a second dataset representative of a (e.g., potential) security vulnerability of DC 104 (e.g., a CVE)). In some embodiments, and as also shown in FIG. 4, data aggregator receives datasets representative of other information regarding resource 224 and/or DC 104, e.g., component inventory information 426 and/or life cycle information 432. In embodiments, data aggregator 202 receives the datasets in a similar manner as described with respect to step 304 of flowchart 300 of FIG. 3 and/or FIG. 4, as well as elsewhere herein.

In step 604, a graph comprising a plurality of nodes and relationships between the plurality of nodes is generated based at least on the first and second datasets, the plurality of nodes comprising a first node representative of the first resource. For example, data aggregator 202 of FIG. 2 generates a graph representative of a plurality of nodes and relationships between the plurality of nodes based at least on resource inventory information 422 and vulnerability information 438, wherein the plurality of nodes comprises a first node representative of resource 224. In this context, data aggregator 202 generates a hierarchical and peer-to-peer representation of resources of DC 104. In an embodiment, a “policy schema” language is defined that describes the relationships between resources.

In embodiments, the graph can be generated and/or represented in various ways. For instance, FIG. 7 shows an example graph 700 showing a relationship between resources, in accordance with an embodiment. As shown in FIG. 7, graph 700 shows a node 702 representative of an account A1 (e.g., a user account or a tenant account), a node 704 representative of a first resource R1, a node 706 representative of a second resource R2, a node 708 representative of a third resource R3, and a node 710 representative of a fourth resource R4. R1, R2, R3, and R4 are physical resources of DC 104. For instance, in a non-limiting example, suppose R1 is server 126A of FIG. 1, R2 is server 126n of FIG. 1, R3 is server 126B of FIG. 1, and R4 is another server of servers 126A-126n, not shown in FIG. 1 for brevity and clarity. In an embodiment, suppose R2 and R4 are configured as storage nodes/storage servers of server infrastructure 106. In an embodiment nodes 704-710 indicate properties of respective resources R1, R2, R3, and/or R4. In an embodiment, A1 is an account created by and/or associated with a user of a tenant of a service (e.g., a cloud service) of DC 104. In an embodiment, node 702 indicates properties of A1 (e.g., an access level thereof, a creation date thereof, an identity of an associated user or tenant, contact information of the associated user or tenant, an associated admin that created the account, a manager of the associated user, and/or the like).

As shown in FIG. 7, graph 700 also comprises an edge 712 connecting nodes 702 and 704, an edge 714 connecting nodes 704 and 706, an edge 716 connecting nodes 702 and 708, and an edge 718 connecting nodes 708 and 710. In this context, edge 712 represents a relationship between nodes 702 and 704, edge 714 represents a relationship between nodes 704 and 706, edge 716 represents a relationship between nodes 702 and 708, and edge 718 represents a relationship between nodes 708 and 710. For instance, in an example, edge 712 represents A1 having access to R1, edge 714 represents R1 having access to R2, edge 716 represents A1 having access to R3, and edge 718 represents R3 having access to R4. In an embodiment, edges 712-718 indicate a type of access a node has to another node (e.g., administrative access, usage access, limited usage access, read-only access, transmit/write only access, and/or the like). In accordance with an embodiment, an edge indicates activity a resource or account of a node has with another resource or account. For instance, in an example, edge 712 indicates activity A1 has with respect to R1.

Flowchart 600 continues with step 606. In step 606, the graph is utilized to determine the first resource fails to satisfy the first rule based at least on a relationship between the first node and a second node representative of a second resource of the plurality of resources. For example, in accordance with an embodiment, compliance determiner 206 determines resource 224 fails to satisfy a rule of policy 138 based at least on a relationship between node 704 and node 702 (e.g., based on edge 712) and/or a relationship between node 704 and 706 (e.g., based on edge 714). For instance, in an embodiment, compliance determiner 206 determines A1 having access to R1 is against the rule of policy 138 (e.g., a permission level of A1 does not satisfy an access policy to R1, a creation date of A1 indicates a potential malicious actor, a previous activity of A1 indicates a potential malicious actor, A1 is to have access to R1 revoked, and/or the like). In another example, compliance determiner 206 determines the relationship between R1 and R2 (e.g., indicated by edge 714) is against a rule of policy 138 (e.g., a security level of data stored by R2 is above the security level of R1, data stored by R2 is unrelated to operations of R1, R1 and R2 are assigned to unrelated tenants or users, and/or the like). In an embodiment, compliance determiner 206 is able to evaluate multiple (e.g., all matching) policies applicable to the resource. In embodiments, if compliance determiner 206 determines a resource fails a rule of policy 138 based on a graph (e.g., graph 700), flow continues in a similar manner as described with respect to step 310 of flowchart 300 of FIG. 3.

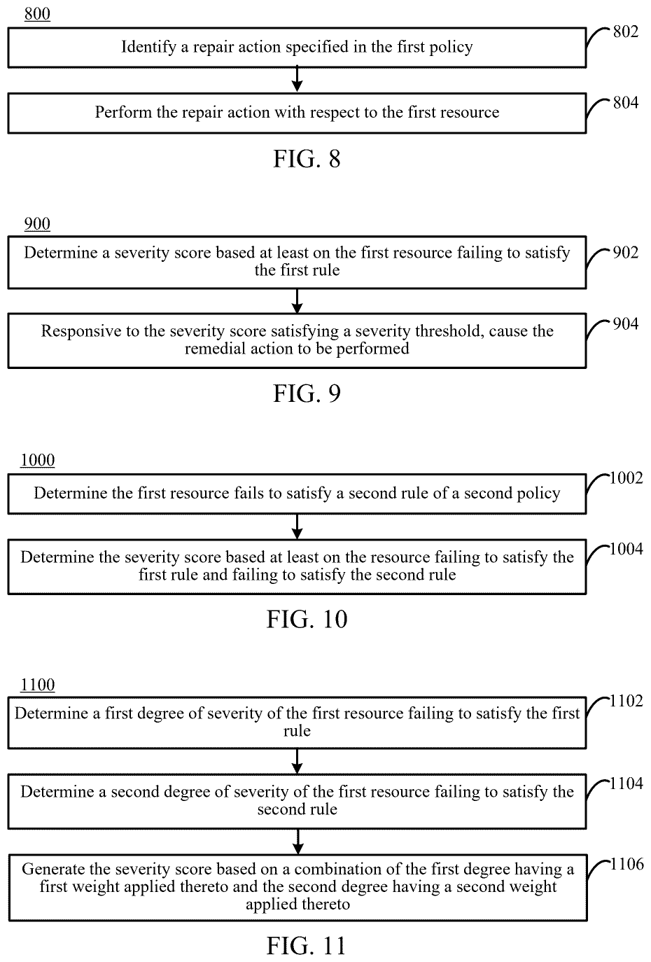

As described herein, compliance determiner 206 causes remedial actions to be performed. Remedial actions can be caused to be performed in various ways, in embodiments. For example, FIG. 8 shows a flowchart 800 of a process for causing a remedial action to be performed, in accordance with an embodiment. In an embodiment, detection and compliance engine 110 operates according to one or more steps of flowchart 800. Note that not all steps of flowchart 800 need be performed in all embodiments. Further structural and operational embodiments will be apparent to persons skilled in the relevant art(s) based on the following description of FIG. 8 with respect to FIG. 2.

Flowchart 800 begins with step 802. In step 802, a repair action specified in the first policy is identified. For example, in an embodiment, policy 138 specifies repair action 222 to be performed if its rule is not satisfied.

In step 804, the repair action is performed with respect to the first resource. For example, in an embodiment, compliance determiner 206 causes repair action 222 to be performed with respect to resource 224 (e.g., by providing instructions 220 to automatic resource repairer 114). By performing repair actions based on definitions within a policy, repairs can be customized based on the particular rule that is not satisfied.

As described herein, remedial actions can be caused to be performed in various ways, in embodiments. For example, FIG. 9 shows a flowchart 900 of a process for causing a remedial action to be performed, in accordance with another embodiment. In an embodiment, detection and compliance engine 110 operates according to one or more steps of flowchart 900. Note that not all steps of flowchart 900 need be performed in all embodiments. Further structural and operational embodiments will be apparent to persons skilled in the relevant art(s) based on the following description of FIG. 9 with respect to FIG. 2.

Flowchart 900 begins with step 902. In step 902, a severity score is determined based at least on the first resource failing to satisfy the first rule. For example, compliance determiner 206 of FIG. 2 in an embodiment determines a severity score based at least on resource 224 failing to satisfy a rule of policy 138. In an embodiment, a severity score is a binary value representing whether or not the first resource satisfies the first rule (e.g., pass/fail, true/falls, 1/0, yes/no, and/or the like). In another embodiment, a severity score represents a degree by which a resource fails or satisfies a rule. For example, suppose a firmware version of a physical resource is outdated, in this example a higher severity score is assigned to a physical resource with an older firmware version (e.g., 3 or more versions older than the current version of firmware) than to a physical resource with an outdated firmware version that is more recent than the older version (e.g., 1 or 2 versions older than the current version of firmware). In an embodiment, a severity score is an aggregated score of rules and/or policies resource 224 fails to satisfy (e.g., a higher severity score is assigned to resource 224 if it fails multiple rules than if it failed (e.g. only) one of those rules). For instance, in a non-limiting example, a “Low” severity score is assigned to resource 224 if it fails a first rule of a first policy, a (e.g., relatively) “Medium” severity score is assigned to resource 224 if it fails the first rule and a second rule of a second policy, and a (e.g., relatively) “High” severity score is assigned to resource 224 if it fails to satisfy the first rule, the second rule, and a third rule of a third policy.

In step 904, responsive to the severity score satisfying a severity threshold, the remedial action is caused to be performed. For example, compliance determiner 206 of FIG. 2 causes a remedial action to be performed responsive to the severity score determined in step 904 satisfying a severity threshold. In an embodiment, different rules of policies have different severity thresholds. In this context, a degree to which failure of a rule impacts performance or security of a physical resource can be assigned to rules. For instance, suppose a first rule defines a likelihood that a physical resource is at risk of a CVE and failure of this first rule has a relatively high degree to which failure of the rule impacts security of the physical resource. Further suppose a second rule defines a likelihood that a configuration mismatch impacts security of the physical resource and failure thereof has a relatively (in comparison to the first rule) low degree to which failure of the rule impacts security. Further details regarding multiple rules and failure thereof are described with respect to FIGS. 10 and 11 as well as elsewhere herein.

Severity scores can be determined in various ways, in embodiments. For instance, FIG. 10 shows a flowchart 1000 of a process for determining a severity score, in accordance with an embodiment. In an embodiment, detection and compliance engine 110 operates according to one or more steps of flowchart 1000. Note that not all steps of flowchart 1000 need be performed in all embodiments. Further structural and operational embodiments will be apparent to persons skilled in the relevant art(s) based on the following description of FIG. 10 with respect to FIG. 2.

Flowchart 1000 begins with step 1002. In step 1002, the first resource is determined to fail to satisfy a second rule of a second policy. For example, compliance determiner 206 of FIG. 2 determines resource 224 fails to satisfy a second rule of a second policy. The second policy specifies the second rule applying to resource 224. In an embodiment, the second policy specifies multiple rules that apply to resource 224. In an embodiment determines resource 224 fails to satisfy the second rule in a similar manner as described with respect to step 308 of flowchart 300 of FIG. 3, as well as elsewhere herein.

In step 1004, the severity score is determined based at least on the resource failing to satisfy the first rule and failing to satisfy the second rule. For example, compliance determiner 206 of FIG. 2 determines a severity score fails based at least on the resource failing to satisfy the first rule and failing to satisfy the second rule. In an embodiment, compliance determiner 206 determines the severity score or respective severity sub-scores in similar manners as described with respect to step 902, as well as elsewhere herein. In an implementation, compliance determiner 206 of FIG. 2 determines the severity score based at least on resource 224 failing to satisfy the first and second rules. Depending on the implementation, compliance determiner 206 determines the score based on the highest severity level among failed rules, a combination of severity levels of failed rules, and/or the like. Additional details regarding determining a score based on a combination of degrees to which resource 224 fails to satisfy multiple rules are described with respect to FIG. 11, as well as elsewhere herein.

As described herein, severity scores can be determined in various ways, in embodiments. For instance, FIG. 11 shows a flowchart 1100 of a process for determining a severity score, in accordance with another embodiment. In an embodiment, detection and compliance engine 110 operates according to one or more steps of flowchart 1100. Note that not all steps of flowchart 1100 need be performed in all embodiments. Further structural and operational embodiments will be apparent to persons skilled in the relevant art(s) based on the following description of FIG. 11 with respect to FIG. 2.

Flowchart 1100 starts with step 1102. In step 1102, a first degree of severity of the first resource failing to satisfy the first rule is determined. For example, compliance determiner 206 determines a first degree of severity by which resource 224 fails to satisfy the rule of policy 138. In an embodiment, the first degree of severity is a binary indication of failure. Alternatively, the first degree of severity is a value along a scale of an amount or measure by which resource 224 fails the rule of policy 138. In an embodiment, compliance determiner 206 generates a severity sub-score representative of the first degree of severity.

In step 1104, a second degree of severity of the first resource failing to satisfy the second rule is determined. For example, compliance determiner 206 determines a second degree of severity by which resource 224 fails to satisfy the rule of the other policy. In an embodiment, the second degree of severity is a binary indication of failure. Alternatively, the second degree of severity is a value along a scale of an amount or measure by which resource 224 fails the rule of the other policy. In an embodiment, compliance determiner 206 generates a severity sub-score representative of the second degree of severity.

In step 1106, the severity score is generated based at least on a combination of the first degree having a first weight applied thereto and the second degree having a second weight applied thereto. For example, compliance determiner 206 determines the severity score based at least on a combination of the first degree determined in step 1102 and the second degree determined in step 1104. In an embodiment, the combination represents an average or sum of the first and second degrees (e.g., and, optionally, degrees by which resource 224 fails to satisfy other rules of the policies and/or of other policies). In an embodiment, weights are applied to different degrees of severity to determine the severity score. In this context, a weight affects how much a degree of severity with respect to a rule impacts the overall severity score for a resource. By applying weights in this manner, embodiments can increase or decrease a relative importance of policies or rules to operation and/or security of resources.

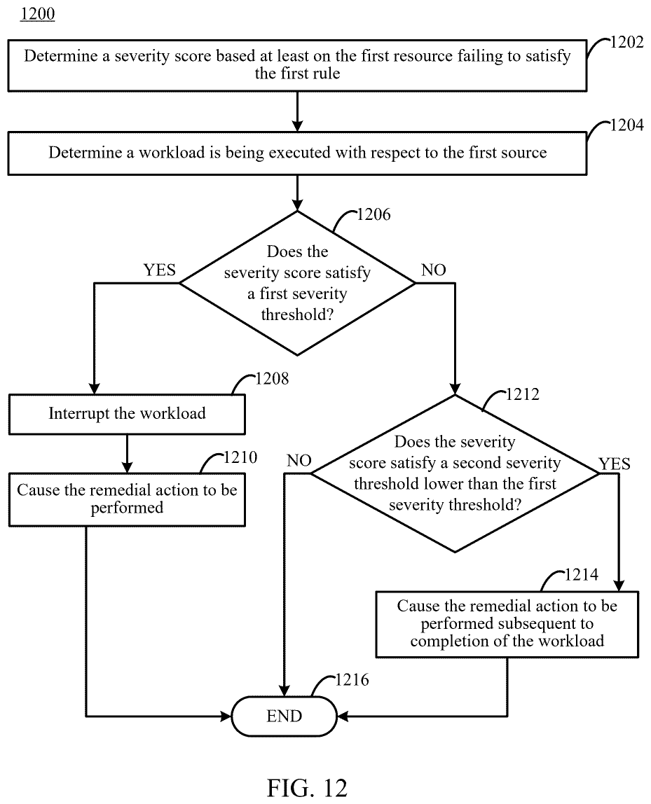

As described herein, remedial actions can be caused to be performed in various ways, in embodiments. For example, FIG. 12 shows a flowchart 1200 of a process for determining whether to cause a remedial action to be performed, in accordance with an embodiment. In an embodiment, detection and compliance engine 110 operates according to one or more steps of flowchart 1200. Note that not all steps of flowchart 1200 need be performed in all embodiments. Further structural and operational embodiments will be apparent to persons skilled in the relevant art(s) based on the following description of FIG. 12 with respect to FIG. 2.

Flowchart 1200 begins with step 1202. In step 1202, a severity score is determined based at least on the first resource failing to satisfy the first rule. For example, compliance determiner 206 of FIG. 2 determines a severity score based at least on resource 224 failing to satisfy the first rule of policy 138, e.g., in a similar manner as described with respect to step 902 of flowchart 900 of FIG. 9, as well as elsewhere herein.

In step 1204, a workload is determined to being executed with respect to the first resource. For example, suppose resource 224 is server 126A. In this context, compliance determiner 206 (or automatic resource repairer 114 instructed to perform a repair action) determines server 126A is executing workload 130 with respect to application 128. In an embodiment, compliance determiner 206 determines server 126A is executing workload 130 based at least on aggregated data 214, querying server 126A, accessing an activity log of server 126A, or accessing a log of outstanding/in-progress workloads.

In step 1206, a determination of whether or not the severity score satisfies a first severity threshold is made. For example, compliance determiner 206 determines whether or not the severity score determined in step 1202 satisfies a first severity threshold. In accordance with an embodiment, the first severity threshold defines a value of the severity score that, if satisfied, causes flowchart 1200 to step 1208, e.g., a number determined based at least on a combination of severity levels or degrees of severity of failed rules. In accordance with another embodiment, the first severity threshold is a number of rules a resource has failed. In accordance with an embodiment, the first severity threshold defines a threshold by which failure of a single or subset of rules are failed to cause flowchart 1200 to continue to step 1208. For instance, in an embodiment, if a (e.g., single) rule of policy 138 is failed (e.g., in which the rule of policy 138 specifies a critical operation or critical security vulnerability), the first severity threshold is satisfied and flowchart 1200 continues to step 1208. If the first severity threshold is not satisfied, flowchart 1200 continues to step 1212.

In step 1208, the workload is interrupted. For example, in accordance with an embodiment, compliance determiner 206 or automatic resource repairer 114 of FIG. 2 causes workload 130 to be interrupted. Depending on the implementation, workload 130 is closed or paused. In an embodiment, compliance determiner 206 or automatic resource repairer 114 cause workload 130 to be migrated to another resource (e.g., another server of servers 126A-126n).

In step 1210, the remedial action is caused to be performed. For example, compliance determiner 206 of FIG. 2 causes the remedial action to be performed. In this manner, embodiments of the present disclosure interrupt workloads if a vulnerability is determined to be critical (e.g., would cause an error in the workload being performed, poses a security risk above an acceptable limit, and/or the like), thereby improving security with respect to physical resources of a data center. Subsequent to step 1210, flowchart 1200 ends with step 1216 (e.g., monitoring continues for any further vulnerabilities or changes in resources).

In step 1212, a determination of whether or not the severity score satisfies a second severity threshold lower than the first severity threshold is made. For example, compliance determiner 206 of FIG. 2 determines whether or not the severity score determined in step 1202 satisfies a second severity threshold lower than the first severity threshold. In this context, the second severity threshold can be referred to as a moderate or low priority threshold. If the severity score does not satisfy the second severity threshold, flowchart 1200 ends with step 1216 (e.g., no remedial action is performed, monitoring continues for any further vulnerabilities or changes in resources, etc.). In this context, remedial actions that are deemed unnecessary are avoided. If the second severity threshold is satisfied, flowchart 1200 continues to step 1214.

In step 1214, the remedial action is caused to be performed subsequent to completion of the workload. For example, compliance determiner 206 of FIG. 2 causes the remedial action to be performed subsequent to workload 130 being completed. In this context, such embodiments mitigate vulnerabilities or errors in configurations without impacting workloads, thereby improving user experience and interfaces. Furthermore, as a workload is not interrupted, compute resources that would be expended pausing and/or restarting the workload are conserved (e.g., if the risk a vulnerability or error presents is below an acceptable limit). Subsequent to step 1214, flowchart 1200 ends with step 1216 (e.g., monitoring continues for any further vulnerabilities or changes in resources).

In an embodiment, compliance determiner 206 schedules the remedial action to be performed at a later date or in relation to a triggering event. For instance, in an embodiment, compliance determiner 206 schedules the remedial action to be performed the next time resource 224 is rebooted. In a further embodiment, compliance determiner 206 places a time limit or restriction on the remedial action. If the time limit or restriction is reached, the remedial action is caused to be performed. For instance, in a non-limiting example, a remedial action comprises updating a firmware or software of resource 224 and compliance determiner 206 schedules the update to occur on the next reboot of resource 224; however, compliance determiner 206 also places a time limit wherein if resource 224 is not rebooted within a predetermined amount of time (e.g., three days) compliance determiner 206, the scheduled remedial action, and/or automatic resource repairer 114 causes resource 224 to reboot and the update to occur. In this context, a remedial action that is not initially critical (e.g., the corresponding severity score fails to satisfy the first threshold) is performed within a predefined limit (e.g., a limit determined based on the corresponding policy). In accordance with an embodiment, the predetermined amount of time is based on which fault codes are flagged by change detector 118.

As described above, flowchart 1200 ends with step 1216. In step 1216, monitoring continues for any further vulnerabilities or changes in resources (e.g., such a change that would cause automatic detection as described with respect to step 302 of flowchart 300 of FIG. 3).

### III. Example Computer System Implementation

Embodiments of maintenance window determination, maintenance window validation, and/or power consumption forecasting described herein are implemented in hardware, or hardware combined with one or both of software and/or firmware. For example, data monitor 108, detection and compliance engine 110, policy manager 112, automatic resource repairer 114, application 122, application 128, VM 134, data aggregator 202, policy determiner 204, compliance determiner 206, inventory monitor 402, resource monitor 404, vulnerability monitor 406, and/or the components described therein, and/or the steps of flowcharts 300, 500, 600, 800, 900, 1000, 1100, and/or 1200, are each implemented as computer program code/instructions configured to be executed in one or more processors and stored in a computer readable storage medium. Alternatively, data monitor 108, detection and compliance engine 110, policy manager 112, automatic resource repairer 114, data aggregator 202, policy determiner 204, compliance determiner 206, inventory monitor 402, resource monitor 404, vulnerability monitor 406, and/or the components described therein, and/or the steps of flowcharts 300, 500, 600, 800, 900, 1000, 1100, and/or 1200 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

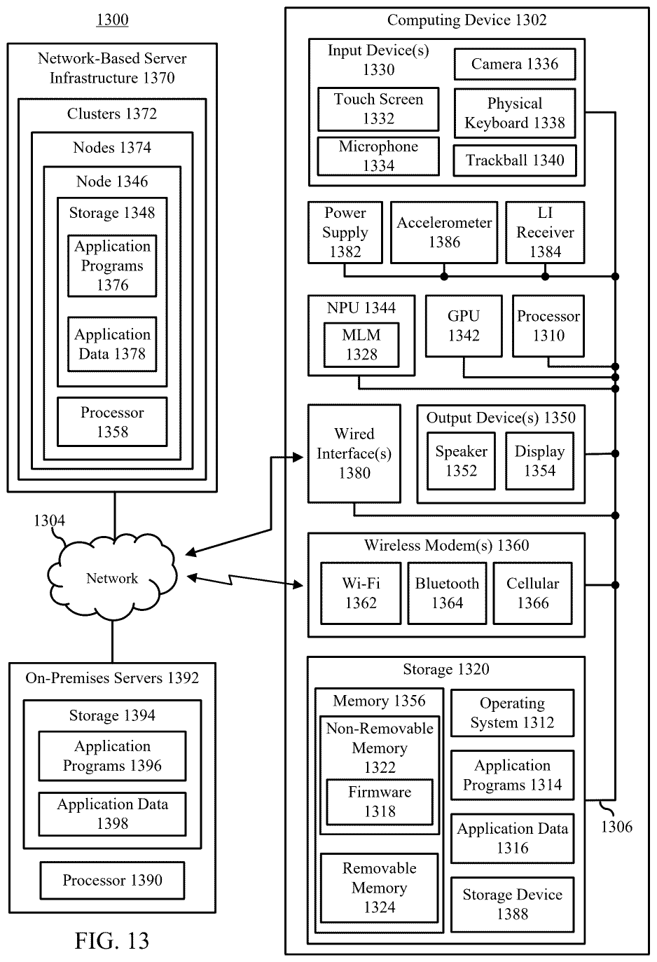

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 13. FIG. 13 shows a block diagram of an exemplary computing environment 1300 that includes a computing device 1302. Computing device 1302 is an example of user computing device 102, server 126A, server 126B, and/or server 126n, which each include one or more of the components of computing device 1302. In some embodiments, computing device 1302 is communicatively coupled with devices (not shown in FIG. 13) external to computing environment 1300 via network 1304. Network 1304 is an example of network 140. Network 1304 comprises one or more networks such as local area networks (LANs), wide area networks (WANs), enterprise networks, the Internet, etc. In examples, network 1304 includes one or more wired and/or wireless portions. In some examples, network 1304 additionally or alternatively includes a cellular network for cellular communications. Computing device 1302 is described in detail as follows.

Computing device 1302 can be any of a variety of types of computing devices. Examples of computing device 1302 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1302 is a stationary computing device such as a desktop computer, a personal computer (PC), a stationary server device, a minicomputer, a mainframe, a supercomputer, etc.

As shown in FIG. 13, computing device 1302 includes a variety of hardware and software components, including a processor 1310, a storage 1320, a graphics processing unit (GPU) 1342, a neural processing unit (NPU) 1344, one or more input devices 1330, one or more output devices 1350, one or more wireless modems 1360, one or more wired interfaces 1380, a power supply 1382, a location information (LI) receiver 1384, and an accelerometer 1386. Storage 1320 includes memory 1356, which includes non-removable memory 1322 and removable memory 1324, and a storage device 1388. Storage 1320 also stores an operating system 1312, application programs 1314, and application data 1316. Wireless modem(s) 1360 include a Wi-Fi modem 1362, a Bluetooth modem 1364, and a cellular modem 1366. Output device(s) 1350 includes a speaker 1352 and a display 1354. Input device(s) 1330 includes a touch screen 1332, a microphone 1334, a camera 1336, a physical keyboard 1338, and a trackball 1340. Not all components of computing device 1302 shown in FIG. 13 are present in all embodiments, additional components not shown may be present, and in a particular embodiment any combination of the components are present. In examples, components of computing device 1302 are mounted to a circuit card (e.g., a motherboard) of computing device 1302, integrated in a housing of computing device 1302, or otherwise included in computing device 1302. The components of computing device 1302 are described as follows.

In embodiments, a single processor 1310 (e.g., central processing unit (CPU), microcontroller, a microprocessor, signal processor, ASIC (application specific integrated circuit), and/or other physical hardware processor circuit) or multiple processors 1310 are present in computing device 1302 for performing such tasks as program execution, signal coding, data processing, input/output processing, power control, and/or other functions. In examples, processor 1310 is a single-core or multi-core processor, and each processor core is single-threaded or multithreaded (to provide multiple threads of execution concurrently). Processor 1310 is configured to execute program code stored in a computer readable medium, such as program code of operating system 1312 and application programs 1314 stored in storage 1320. The program code is structured to cause processor 1310 to perform operations, including the processes/methods disclosed herein. Operating system 1312 controls the allocation and usage of the components of computing device 1302 and provides support for one or more application programs 1314 (also referred to as “applications” or “apps”). In examples, application programs 1314 include common computing applications (e.g., e-mail applications, calendars, contact managers, web browsers, messaging applications), further computing applications (e.g., word processing applications, mapping applications, media player applications, productivity suite applications), one or more ML models, as well as applications related to the embodiments disclosed elsewhere herein. In examples, processor(s) 1310 includes one or more general processors (e.g., CPUs) configured with or coupled to one or more hardware accelerators, such as one or more NPUs 1344 and/or one or more GPUs 1342.

Any component in computing device 1302 can communicate with any other component according to function, although not all connections are shown for ease of illustration. For instance, as shown in FIG. 13, bus 1306 is a multiple signal line communication medium (e.g., conductive traces in silicon, metal traces along a motherboard, wires, etc.) present to communicatively couple processor 1310 to various other components of computing device 1302, although in other embodiments, an alternative bus, further buses, and/or one or more individual signal lines is/are present to communicatively couple components. Bus 1306 represents one or more of any of several types of bus structures, including a memory bus or memory controller, a peripheral bus, an accelerated graphics port, and a processor or local bus using any of a variety of bus architectures.

Storage 1320 is physical storage that includes one or both of memory 1356 and storage device 1388, which store operating system 1312, application programs 1314, and application data 1316 according to any distribution. Non-removable memory 1322 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1322 includes main memory and is separate from or fabricated in a same integrated circuit as processor 1310. As shown in FIG. 13, non-removable memory 1322 stores firmware 1318 that is present to provide low-level control of hardware. Examples of firmware 1318 include BIOS (Basic Input/Output System, such as on personal computers) and boot firmware (e.g., on smart phones). In examples, removable memory 1324 is inserted into a receptacle of or is otherwise coupled to computing device 1302 and can be removed by a user from computing device 1302. Removable memory 1324 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1388 are present that are internal and/or external to a housing of computing device 1302 and are or are not removable. Examples of storage device 1388 include a hard disk drive, a SSD, a thumb drive (e.g., a USB (Universal Serial Bus) flash drive), or other physical storage device.

One or more programs are stored in storage 1320. Such programs include operating system 1312, one or more application programs 1314, and other program modules and program data. Examples of such application programs include computer program logic (e.g., computer program code/instructions) for implementing embodiments described herein, and/or the components described therein, and/or the steps of flowcharts described herein, and/or any individual steps thereof.

Storage 1320 also stores data used and/or generated by operating system 1312 and application programs 1314 as application data 1316. Examples of application data 1316 include web pages, text, images, tables, sound files, video data, and other data. In examples, application data 1316 is sent to and/or received from one or more network servers or other devices via one or more wired or wireless networks. Storage 1320 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1302 through one or more input devices 1330 and receives information from computing device 1302 through one or more output devices 1350. Input device(s) 1330 includes one or more of touch screen 1332, microphone 1334, camera 1336, physical keyboard 1338 and/or trackball 1340 and output device(s) 1350 includes one or more of speaker 1352 and display 1354. Each of input device(s) 1330 and output device(s) 1350 are integral to computing device 1302 (e.g., built into a housing of computing device 1302) or are external to computing device 1302 (e.g., communicatively coupled wired or wirelessly to computing device 1302 via wired interface(s) 1380 and/or wireless modem(s) 1360). Further input devices 1330 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1354 displays information, as well as operating as touch screen 1332 by receiving user commands and/or other information (e.g., by touch, finger gestures, virtual keyboard, etc.) as a user interface. Any number of each type of input device(s) 1330 and output device(s) 1350 are present, including multiple microphones 1334, multiple cameras 1336, multiple speakers 1352, and/or multiple displays 1354.

In embodiments where GPU 1342 is present, GPU 1342 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1342 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1344 (also referred to as an “artificial intelligence (AI) accelerator” or “deep learning processor (DLP)”) is a processor or processing unit configured to accelerate artificial intelligence and ML applications, such as execution of ML model (MLM) 1328. In an example, NPU 1344 is configured for a data-driven parallel computing and is highly efficient at processing massive multimedia data such as videos and images and processing data for neural networks. NPU 1344 is configured for efficient handling of AI-related tasks, such as speech recognition, background blurring in video calls, photo or video editing processes like object detection, etc.

In embodiments disclosed herein that implement ML models, NPU 1344 can be utilized to execute such ML models, of which MLM 1328 is an example. For instance, where applicable, MLM 1328 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and generating forecasts on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1344 is used to train MLM 1328. To train MLM 1328, training data is that includes input features (attributes) and their corresponding output labels/target values (e.g., for supervised learning) is collected. A training algorithm is a computational procedure that is used so that MLM 1328 learns from the training data. Parameters/weights are internal settings of MLM 1328 that are adjusted during training by the training algorithm to reduce a difference between forecasts by MLM 1328 and actual outcomes (e.g., output labels). In some examples, MLM 1328 is set with initial values for the parameters/weights. A loss function measures a dissimilarity between forecasts by MLM 1328 and the target values, and the parameters/weights of MLM 1328 are adjusted to minimize the loss function. The parameters/weights are iteratively adjusted by an optimization technique, such as gradient descent. In this manner, MLM 1328 is generated through training by NPU 1344 to be used to generate inferences based on received input feature sets for particular applications. MLM 1328 is generated as a computer program or other type of algorithm configured to generate an output (e.g., a classification, a forecast/inference) based on received input features, and is stored in the form of a file or other data structure.

In examples, such training of MLM 1328 by NPU 1344 is supervised or unsupervised. According to supervised learning, input objects (e.g., a vector of forecasting variables) and a desired output value (e.g., a human-labeled supervisory signal) train MLM 1328. The training data is processed, building a function that maps new data on expected output values. Example algorithms usable by NPU 1344 to perform supervised training of MLM 1328 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1328 is an LLM, MLM 1328 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1328 is trained to learn patterns from unlabeled data. For instance, in embodiments where MLM 1328 implements unsupervised learning techniques, MLM 1328 identifies one or more classifications or clusters to which an input belongs. During a training phase of MLM 1328 according to unsupervised learning, MLM 1328 tries to mimic the provided training data and uses the error in its mimicked output to correct itself (i.e., correct weights and biases). In further examples, NPU 1344 perform unsupervised training of MLM 1328 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1344 need not necessarily be present in all ML model embodiments. In embodiments where ML models are present, any one or more of processor 1310, GPU 1342, and/or NPU 1344 can be present to train and/or execute MLM 1328.

One or more wireless modems 1360 can be coupled to antenna(s) (not shown) of computing device 1302 and can support two-way communications between processor 1310 and devices external to computing device 1302 through network 1304, as would be understood to persons skilled in the relevant art(s). Wireless modem 1360 is shown generically and can include a cellular modem 1366 for communicating with one or more cellular networks, such as a GSM network for data and voice communications within a single cellular network, between cellular networks, or between the mobile device and a public switched telephone network (PSTN). In examples, wireless modem 1360 also or alternatively includes other radio-based modem types, such as a Bluetooth modem 1364 (also referred to as a “Bluetooth device”) and/or Wi-Fi modem 1362 (also referred to as an “wireless adaptor”). Wi-Fi modem 1362 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1364 is configured to communicate with another Bluetooth-capable device according to the Bluetooth short-range wireless technology standard(s) such as IEEE 802.15.1 and/or managed by the Bluetooth Special Interest Group (SIG).

Computing device 1302 can further include power supply 1382, LI receiver 1384, accelerometer 1386, and/or one or more wired interfaces 1380. Example wired interfaces 1380 include a USB port, IEEE 1394 (FireWire) port, a RS-132 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1380 of computing device 1302 provide for wired connections between computing device 1302 and network 1304, or between computing device 1302 and one or more devices/peripherals when such devices/peripherals are external to computing device 1302 (e.g., a pointing device, display 1354, speaker 1352, camera 1336, physical keyboard 1338, etc.). Power supply 1382 is configured to supply power to each of the components of computing device 1302 and receives power from a battery internal to computing device 1302, and/or from a power cord plugged into a power port of computing device 1302 (e.g., a USB port, an A/C power port). LI receiver 1384 is useable for location determination of computing device 1302 and in examples includes a satellite navigation receiver such as a Global Positioning System (GPS) receiver and/or includes other type of location determiner configured to determine location of computing device 1302 based on received information (e.g., using cell tower triangulation, etc.). Accelerometer 1386, when present, is configured to determine an orientation of computing device 1302.

Note that the illustrated components of computing device 1302 are not required or all-inclusive, and fewer or greater numbers of components can be present as would be recognized by one skilled in the art. In examples, computing device 1302 includes one or more of a gyroscope, barometer, proximity sensor, ambient light sensor, digital compass, etc. In an example, processor 1310 and memory 1356 are co-located in a same semiconductor device package, such as being included together in an integrated circuit chip, FPGA, or system-on-chip (SOC), optionally along with further components of computing device 1302.

In embodiments, computing device 1302 is configured to implement any of the above-described features of flowcharts herein. Computer program logic for performing any of the operations, steps, and/or functions described herein is stored in storage 1320 and executed by processor 1310.

In some embodiments, server infrastructure 1370 is present in computing environment 1300 and is communicatively coupled with computing device 1302 via network 1304. Server infrastructure 1370, when present, is a network-accessible server set (e.g., a cloud-based environment or platform). Server infrastructure 1370 is an example of server infrastructure 106, in an embodiment. As shown in FIG. 13, server infrastructure 1370 includes clusters 1372. Each of clusters 1372 comprises a group of one or more compute nodes and/or a group of one or more storage nodes. For example, as shown in FIG. 13, cluster 1372 includes nodes 1374. Each of nodes 1374 are accessible via network 1304 (e.g., in a “cloud-based” embodiment) to build, deploy, and manage applications and services. In examples, any of nodes 1374 is a storage node that comprises a plurality of physical storage disks, SSDs, and/or other physical storage devices that are accessible via network 1304 and are configured to store data associated with the applications and services managed by nodes 1374.

Each of nodes 1374, as a compute node, comprises one or more server computers, server systems, and/or computing devices. For instance, a node 1374 in an embodiment includes one or more of the components of computing device 1302 disclosed herein. Each of nodes 1374 is configured to execute one or more software applications (or “applications”) and/or services and/or manage hardware resources (e.g., processors, memory, etc.), which are utilized by users (e.g., customers) of the network-accessible server set. In examples, as shown in FIG. 13, nodes 1374 includes a node 1346 that includes storage 1348 and/or one or more of a processor 1358 (e.g., similar to processor 1310, GPU 1342, and/or NPU 1344 of computing device 1302). Storage 1348 stores application programs 1376 and application data 1378. Processor(s) 1358 operate application programs 1376 which access and/or generate related application data 1378. In an implementation, nodes such as node 1346 of nodes 1374 operate or comprise one or more virtual machines, with each virtual machine emulating a system architecture (e.g., an operating system), in an isolated manner, upon which applications such as application programs 1376 are executed.

In embodiments, one or more of clusters 1372 are located/co-located (e.g., housed in one or more nearby buildings with associated components such as backup power supplies, redundant data communications, environmental controls, etc.) to form a DC, or are arranged in other manners. Accordingly, in an embodiment, one or more of clusters 1372 are included in a DC in a distributed collection of DCs. In embodiments, exemplary computing environment 1300 comprises part of a cloud-based platform.

In an embodiment, computing device 1302 accesses application programs 1376 for execution in any manner, such as by a client application and/or a browser at computing device 1302.

In an example, for purposes of network (e.g., cloud) backup and data security, computing device 1302 additionally and/or alternatively synchronizes copies of application programs 1314 and/or application data 1316 to be stored at network-based server infrastructure 1370 as application programs 1376 and/or application data 1378. In examples, operating system 1312 and/or application programs 1314 include a file hosting service client configured to synchronize applications and/or data stored in storage 1320 at network-based server infrastructure 1370.

In some embodiments, on-premises servers 1392 are present in computing environment 1300 and are communicatively coupled with computing device 1302 via network 1304. On-premises servers 1392 are an example of server infrastructure 106, in an embodiment. On-premises servers 1392, when present, are hosted within an organization's infrastructure and, in many cases, physically onsite of a facility of that organization. On-premises servers 1392 are controlled, administered, and maintained by IT (Information Technology) personnel of the organization or an IT partner to the organization. Application data 1398 can be shared by on-premises servers 1392 between computing devices of the organization, including computing device 1302 (when part of an organization) through a local network of the organization, and/or through further networks accessible to the organization (including the Internet). Furthermore, in examples, on-premises servers 1392 serve applications such as application programs 1396 to the computing devices of the organization, including computing device 1302. Accordingly, in examples, on-premises servers 1392 include storage 1394 (which includes one or more physical storage devices such as storage disks and/or SSDs) for storage of application programs 1396 and application data 1398 and include a processor 1390 (e.g., similar to processor 1310, GPU 1342, and/or NPU 1344 of computing device 1302) for execution of application programs 1396. In some embodiments, multiple processors 1390 are present for execution of application programs 1396 and/or for other purposes. In further examples, computing device 1302 is configured to synchronize copies of application programs 1314 and/or application data 1316 for backup storage at on-premises servers 1392 as application programs 1396 and/or application data 1398.

Embodiments described herein may be implemented in one or more of computing device 1302, network-based server infrastructure 1370, and on-premises servers 1392. For example, in some embodiments, computing device 1302 is used to implement systems, clients, or devices, or components/subcomponents thereof, disclosed elsewhere herein. In other embodiments, a combination of computing device 1302, network-based server infrastructure 1370, and/or on-premises servers 1392 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1320. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1314) are stored in storage 1320. Such computer programs can also be received via wired interface(s) 1360 and/or wireless modem(s) 1360 over network 1304. Such computer programs, when executed or loaded by an application, enable computing device 1302 to implement features of embodiments discussed herein. Accordingly, such computer programs represent controllers of the computing device 1302.

Embodiments are also directed to computer program products comprising computer code or instructions stored on any computer-readable medium or computer-readable storage medium. Such computer program products include the physical storage of storage 1320 as well as further physical storage types.

### IX. Additional Exemplary Embodiments

An automatic repair system of a data center is described herein. The automatic repair system comprising a processor and a memory. The memory stores program code executable by the processor circuit to: automatically detect a change in a configuration of a first resource of a plurality of resources of the data center, generate aggregated data representative of a resource inventory of the data center specifying the plurality of resources, determine a first policy of the data center, the first policy specifying a first rule applied to the first resource, determine the first resource fails to satisfy the first rule based at least on the change in the configuration and the aggregated data, cause a remedial action to be performed.

In an implementation of the foregoing automatic repair system, to cause the remedial action to be performed, the programming instructions are further structured to cause the processor to: identify a repair action specified in the first policy, and perform the repair action with respect to the first resource.

In an implementation of the foregoing automatic repair system, the first rule specifies a pattern of a performance issue in resources, and to determine the first resource fails to satisfy the first rule, the programming instructions are further structured to cause the processor to: determine, based at least on the aggregated data or the change in the configuration, a level of similarity between the pattern of the performance issue and a pattern of a performance of the first resource satisfies a similarity criterion.

In an implementation of the foregoing automatic repair system, the programming instructions are further structured to cause the processor to: determine a severity score based at least on the first resource failing to satisfy the first rule; and responsive to the severity score satisfying a severity threshold, cause the remedial action to be performed.

In an implementation of the foregoing automatic repair system, the programming instructions are further structured to cause the processor to: determine the first resource fails to satisfy a second rule of a second policy; and wherein the severity score is determined based at least on the first resource failing to satisfy the first rule and failing to satisfy the second rule.

In an implementation of the foregoing automatic repair system, to determine the severity score, the programming instructions are further structured to cause the processor to: determine a first degree of severity of the first resource failing to satisfy the first rule; determine a second degree of severity of the first resource failing to satisfy the second rule; and generate the severity score based on a combination of the first degree having a first weight applied thereto and the second degree having a second weight applied thereto.

In an implementation of the foregoing automatic repair system, the programming instructions are further structured to cause the processor to: determine a severity score based at least on the first resource failing to satisfy the first rule; determine a workload is being executed with respect to the first resource; in response to the severity score satisfying a first severity threshold: interrupt the workload, and perform the remedial action; and in response to the severity score satisfying a second severity threshold lower than the first severity threshold: perform the remedial action subsequent to completion of the workload.

In an implementation of the foregoing automatic repair system, to generate the aggregated data, the programming instructions are further structured to cause the processor to: receive a first dataset representative of the resource inventory and a second dataset representative of a security vulnerability of the data center; and generate, based on the first and second datasets, a graph comprising a plurality of nodes and relationships between nodes of the plurality of nodes, the plurality of nodes comprising a first node representative of the first resource.

In an implementation of the foregoing automatic repair system, to determine the first resource fails to satisfy the first rule, the programming instructions are further structured to cause the processor to: utilize the graph to determine the first resource fails to satisfy the first rule based at least on a relationship between the first node and a second node representative of a second resource of the plurality of resources.

In an implementation of the foregoing automatic repair system, the automatic repair system is a repair subsystem of a system of a datacenter.

In an implementation of the foregoing automatic repair system, the system of the datacenter comprises the automatic repair system and a plurality of server devices.

In an implementation of the foregoing automatic repair system, the plurality of server devices comprise the first resource.

In an implementation of the foregoing automatic repair system, the first resource is a physical resource.

A method for repairing a resource of a DC is described herein. The method comprises: automatically detecting a change in a configuration of a first resource, generating aggregated data representative of a resource inventory of the data center, the resource inventory specifying a plurality of resources of the data center; determining a first policy of the data center, the first policy specifying a first rule applied to a first resource of the plurality of resources; determining the first resource fails to satisfy the first rule based at least on the change in the configuration or the aggregated data; and causing a remedial action to be performed based at least on the first resource failing to satisfy the rule.

In an implementation of the foregoing method, said causing the remedial action to be performed comprises: identifying a repair action specified in the first policy; and performing the repair action with respect to the first resource.

In an implementation of the foregoing method, wherein the first rule specifies a pattern of a performance issue in resources, and said determining the first resource fails to satisfy the first rule comprises: determining, based at least on the aggregated data or the change in the configuration, a level of similarity between the pattern of the performance issue and a pattern of a performance of the first resource satisfies a similarity criterion.

In an implementation of the foregoing method, the method further comprises: determining a severity score based at least on the first resource failing to satisfy the first rule; and responsive to the severity score satisfying a severity threshold, causing the remedial action to be performed.

In an implementation of the foregoing method, the method further comprises: determining the first resource fails to satisfy a second rule of a second policy; and said determining the severity score is based at least on the first resource failing to satisfy the first rule and failing to satisfy the second rule.

In an implementation of the foregoing method, said determining the severity score further comprises: determining a first degree of severity of the first resource failing to satisfy the first rule; determining a second degree of severity of the first resource failing to satisfy the second rule; and generating the severity score based on a combination of the first degree having a first weight applied thereto and the second degree having a second weight applied thereto.

In an implementation of the foregoing method, the method further comprises: determining a severity score based at least on the first resource failing to satisfy the first rule; determining a workload is being executed with respect to the first resource; in response to the severity score satisfying a first severity threshold: interrupting the workload and performing the remedial action; and in response to the severity score satisfying a second severity threshold lower than the first severity threshold: performing the remedial action subsequent to completion of the workload.

In an implementation of the foregoing method, wherein said generating the aggregated data comprises: receiving a first dataset representative of the resource inventory and a second dataset representative of a security vulnerability of the data center; and generating, based on the first and second datasets, a graph comprising a plurality of nodes and relationships between nodes of the plurality of nodes, the plurality of nodes comprising a first node representative of the first resource.

In an implementation of the foregoing method, wherein said determining the first resource fails to satisfy the first rule comprises: utilizing the graph to determine the first resource fails to satisfy the first rule based at least on a relationship between the first node and a second node representative of a second resource of the plurality of resources.

In an implementation of the foregoing method, the first resource is a physical resource.

A computer-readable storage medium having programming instructions encoded thereon is described herein. The programming instructions structured to cause a processor to perform any of the foregoing methods.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, applications, DCs, data monitors, detection and compliance engines, policy managers, storages, automatic resource repairers, resources, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. An automatic repair system of a data center comprising:
a processor; and
memory storing programming instructions structured to cause the processor to:
automatically detect a change in a configuration of a first resource of a plurality of resources of the data center,
receive a first dataset and a second dataset, the first dataset representative of a resource inventory of the data center specifying the plurality of resources, the second dataset representative of a security vulnerability of the data center,
generate aggregated data based at least on the first dataset and the second dataset,
determine, based at least on the first resource, a first policy of the data center, the first policy specifying a first rule applied to the first resource,
determine the first resource fails to satisfy the first rule based at least on the change in the configuration and the aggregated data,
identify a repair action specified in the first policy, and
cause a repair action to be performed with respect to the first resource.

2. The automatic repair system of claim 1, wherein the first rule specifies a pattern of a performance issue in resources, and to determine the first resource fails to satisfy the first rule, the programming instructions are further structured to cause the processor to:
determine, based at least on the aggregated data or the change in the configuration, a level of similarity between the pattern of the performance issue and a pattern of a performance of the first resource satisfies a similarity criterion.

3. The automatic repair system of claim 2, wherein the programming instructions are further structured to cause the processor to:
determine the pattern of the performance issue based at least on a version of a firmware of a second resource failing to satisfy the first rule; and
to determine the level of similarity satisfies the similarity criterion, the programming instructions are further structured to cause the processor to:
determine a version of a firmware of the first resource is the same as the version of the firmware of the second resource.

4. The automatic repair system of claim 1, wherein the programming instructions are further structured to cause the processor to:
determine a severity score based at least on the first resource failing to satisfy the first rule; and
wherein the programming instructions are structured to cause the processor to cause the repair action to be performed responsive to the severity score satisfying a severity threshold.

5. The automatic repair system of claim 4, wherein a second policy specifies a second rule applied to the first resource and the programming instructions are further structured to cause the processor to:
determine the first resource fails to satisfy the second rule; and
wherein the severity score is determined based at least on the first resource failing to satisfy the first rule and failing to satisfy the second rule.

6. The automatic repair system of claim 5, wherein to determine the severity score, the programming instructions are further structured to cause the processor to:
determine a first degree of severity of the first resource failing to satisfy the first rule;
determine a second degree of severity of the first resource failing to satisfy the second rule; and
generate the severity score based on a combination of the first degree having a first weight applied thereto and the second degree having a second weight applied thereto.

7. The automatic repair system of claim 1, wherein the programming instructions are further structured to cause the processor to:
determine a severity score based at least on the first resource failing to satisfy the first rule;
determine a workload is being executed with respect to the first resource;
in response to the severity score satisfying a first severity threshold:
interrupt the workload, and
perform the repair action; and
in response to the severity score satisfying a second severity threshold lower than the first severity threshold:
cause the repair action to be performed subsequent to completion of the workload.

8. The automatic repair system of claim 1, wherein to generate the aggregated data, the programming instructions are further structured to cause the processor to:
generate, based on the first and second datasets, a graph comprising a plurality of nodes and relationships between nodes of the plurality of nodes, the plurality of nodes comprising a first node representative of the first resource.

9. The automatic repair system of claim 8, wherein to determine the first resource fails to satisfy the first rule, the programming instructions are further structured to cause the processor to:
utilize the graph to determine the first resource fails to satisfy the first rule based at least on a relationship between the first node and a second node representative of a second resource of the plurality of resources.

10. A method for repairing a resource of a data center, the method comprising:
automatically detecting a change in a configuration of a first resource of a plurality of resources of the data center;
responsive to said automatically detecting the change in the configuration, generating aggregated data representative of a resource inventory of the data center, the resource inventory specifying the plurality of resources of the data center;
determining a first policy of the data center, the first policy specifying a first rule applied to the first resource;
determining the first resource fails to satisfy the first rule based at least on the change in the configuration and the aggregated data; and
causing a remedial action to be performed based at least on the first resource failing to satisfy the rule.

11. The method of claim 10, wherein said causing the remedial action to be performed comprises:
identifying a repair action specified in the first policy; and
causing the repair action to be performed with respect to the first resource.

12. The method of claim 10, wherein the first rule specifies a pattern of a performance issue in resources, and said determining the first resource fails to satisfy the first rule comprises:
determining, based at least on the aggregated data or the change in the configuration, a level of similarity between the pattern of the performance issue and a pattern of a performance of the first resource satisfies a similarity criterion.

13. The method of claim 10, further comprising:
determining a severity score based at least on the first resource failing to satisfy the first rule; and
responsive to the severity score satisfying a severity threshold, causing the remedial action to be performed.

14. The method of claim 13, wherein a second policy specifies a second rule applied to the first resource and the method further comprises:
determining the first resource fails to satisfy the second rule; and
said determining the severity score is based at least on the first resource failing to satisfy the first rule and failing to satisfy the second rule.

15. The method of claim 14, wherein said determining the severity score further comprises:
determining a first degree of severity of the first resource failing to satisfy the first rule;
determining a second degree of severity of the first resource failing to satisfy the second rule; and
generating the severity score based on a combination of the first degree having a first weight applied thereto and the second degree having a second weight applied thereto.

16. The method of claim 10, further comprising:
determining a severity score based at least on the first resource failing to satisfy the first rule;
determining a workload is being executed with respect to the first resource;
in response to the severity score satisfying a first severity threshold:
interrupting the workload, and
performing the remedial action; and
in response to the severity score satisfying a second severity threshold lower than the first severity threshold:
performing the remedial action subsequent to completion of the workload.

17. The method of claim 10, wherein said generating the aggregated data comprises:
receiving a first dataset representative of the resource inventory and a second dataset representative of a security vulnerability of the data center; and
generating, based on the first and second datasets, a graph comprising a plurality of nodes and relationships between nodes of the plurality of nodes, the plurality of nodes comprising a first node representative of the first resource.

18. A system comprising:
a plurality of server devices; and
a repair subsystem configured to:
detect a change in a first server of the plurality of server devices,
responsive to detecting the change in the first server, generate aggregated data representative of resources related to the first server,
determine a first policy of the data center, the first policy specifying a first rule applied to the first server or one of the resources,
determine the first resource fails to satisfy the first rule based at least on the aggregated data, and
cause a remedial action to be performed with respect to the first server.

19. The system of claim 18, wherein to cause the remedial action to be performed, the repair subsystem is further configured to:
identify a repair action specified in the first policy; and
perform the repair action with respect to the first server.

20. The system of claim 18, wherein the repair subsystem is further configured to:
determine a severity score based at least on the first server failing to satisfy the first rule;
determine a workload is being executed with respect to the first server;
in response to the severity score satisfying a first severity threshold:
interrupt the workload, and
perform the remedial action; and
in response to the severity score satisfying a second severity threshold lower than the first severity threshold:
perform the remedial action subsequent to completion of the workload.
